(19) United States
(12) Patent Application Publication
(10) Pub. No.: US 2006/0218846 A1
(43) Pub. Date: Oct. 5, 2006

(54) Attachable diving bill with an integrated hook for a lure

(76) Inventor: John W. Guerin, Kennedale, TX (US)

Correspondence Address: MICHAEL L. DIAZ, P.C., 555 REPUBLIC DRIVE, SUITE 200, PIANO, TX, 75074, US

(21) Appl. No.: 11/094,670

(22) Filed: Mar. 30, 2005

(51) Int. Cl. A01K 85/00

(52) U.S. Cl. 43/42.47

(57) ABSTRACT

The present invention is an attachable diving bill with a hook for use with an artificial lure. The diving bill includes an integrated hook, which is used to pierce the artificial lure and extend through lure, thereby providing an exposed curved end and barbed tip. The diving bill may include an eye and a weed guard. The diving bill may modify any lure to move through the water in a similar fashion as a crank bait.

### BACKGROUND OF THE INVENTION

1. Field of the Invention:

This invention relates to artificial fishing lures. Specifically, the present invention relates to an attachable diving bill with an integrated hook for use with a fishing lure.

2. Description of the Related Art:

Artificial bait or lures are used to simulate natural or live species such as insects, amphibians, and fish to attract marine life. There are many types of artificial baits utilized by fishermen. Many types of lures are merely soft plastic lures, which are attached to a hook on a fishing line and cast out into the water. These artificial baits provide only rudimentary movement through the water caused by the fisherman manipulating or pulling the fishing line. However, there is an effective fishing lure, which provides a more natural movement of the artificial bait called a crank bait. A crank bait has a diving bill attached to the outer surface of the fishing lure which provides a movement or “wobble” through the water. The crank bait provides a far more life-like appearance and movement to the lure. As the crank bait is cast into the water, the crank bait moves through the water by the fisherman pulling or “cranking back” the crank bait toward him. The movement of the crank bait is highly desirable because fish are attracted to movement and vibration of underwater objects or marine life. With the use of a crank bait, the fish are far more likely to be attracted to the lure.

Although the use of a crank bait is highly desirable, fisherman oftentimes possess a wide range and number of artificial lures which do not having a diving bill. It would be advantageous to have a diving bill and integrated hook which is attachable to an existing fishing lure.

Thus, it would be a distinct advantage to have a integrated diving bill and hook which may be attachable to any fishing lure to modify the lure into a crank bait. It is an object of the present invention to provide such an apparatus.

### SUMMARY OF THE INVENTION

In one aspect, the present invention is an attachable diving bill for use with an artificial lure. The attachable diving bill includes a diving bill and a hook having a curved end and a tip. The hook is attached to the diving bill. The diving bill is attached to the artificial lure by attaching the hook through the artificial lure with the tip being exposed. The diving bill enables an artificial lure to travel through the water in a similar fashion as a crank bait.

In another aspect, the present invention is an artificial lure having an attachable diving bill. The artificial lure includes an artificial lure having an exterior surface and an interior portion. In addition, a diving bill having a hook with a curved end and a tip is attached to the diving bill. The diving bill is attached to the artificial lure by attaching the hook through the artificial lure with the tip being exposed.

In still another aspect, the present invention is an attachable diving bill for use with an artificial lure. The diving bill includes a support mold. The diving bill is planar. A hook having a curved end and a tip is integrated into the support mold. The diving bill is attached to the artificial lure by piercing an exterior surface of the artificial lure with the hook and allowing the tip to be exposed.

### BRIEF DESCRIPTION OF THE DRAWINGS

FIG. 1 (prior art) is a side view of an existing soft plastic artificial lure without a diving bill;

FIG. 2 is a side perspective view of an attachable diving bill and hook removed from the artificial lure in the preferred embodiment of the present invention;

FIG. 3 is a top view of the diving bill and hook of FIG. 2 in the preferred embodiment of the present invention;

FIG. 4 is a side view of the diving bill and hook; and

FIG. 5 is a side view of the diving bill and hook attached to the artificial lure in the preferred embodiment of the present invention.

### DESCRIPTION OF THE INVENTION

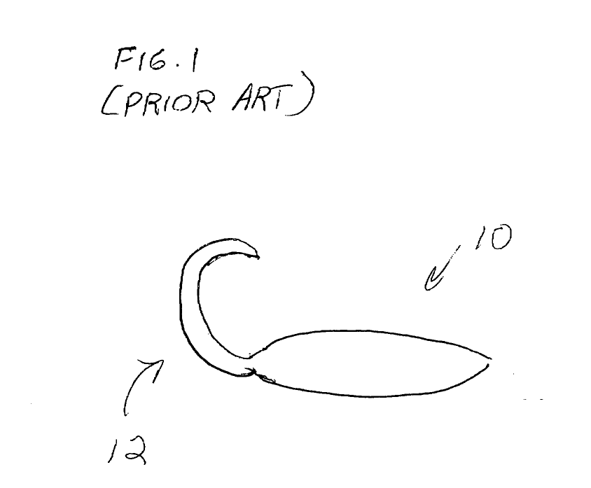

An integrated diving bill and hook which is attachable to a fishing lure is disclosed. FIG. 1 is a side view of an existing artificial lure 10 without a diving bill. The artificial lure may be constructed of a wide variety of materials. However, commonly the artificial lure is constructed of a soft plastic. In addition, the artificial lure may be any size and shape. As depicted in FIG. 1, the artificial lure is a grub having a tail 12 to provide a somewhat realistic appearance of a marine life form. The artificial lure is cast into the water. However, since the artificial lure does not have a diving bill, movement of the lure is limited to action provided by the fisherman upon the fishing line to which the lure is attached.

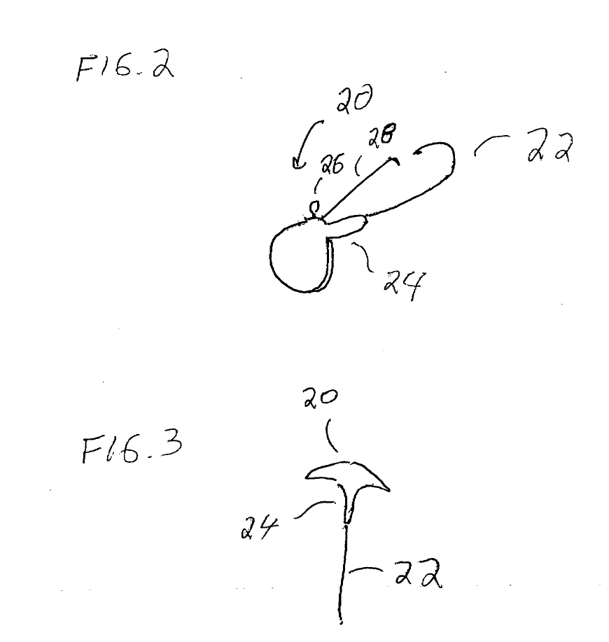

FIG. 2 is a side perspective view of an attachable diving bill 20 removed from the artificial lure 10 in the preferred embodiment of the present invention. FIG. 3 is a top view of the diving bill 20 of FIG. 2 in the preferred embodiment of the present invention. The diving bill includes an integrated hook 22. The integrated hook is preferably fabricated into a support mold 24 extending from the diving bill. The diving bill includes an eye 26 and an optional weed guard 28. The eye is commonly used to connect lines or other objects to a lure. The weed guard may optionally be employed to provide a guard for a lure as it is pulled along the bottom of the water to avoid tangling within weeds.

The diving bill may be constructed of any rigid material, preferably having a density greater than the artificial. The diving bill is preferably constructed of a weighted plastic or metal. In addition, the diving bill is generally planar or flat and round in shape. The diving bill is configured to provide a wobble to an artificial lure in the same manner that a diving bill is used on a crank bait.

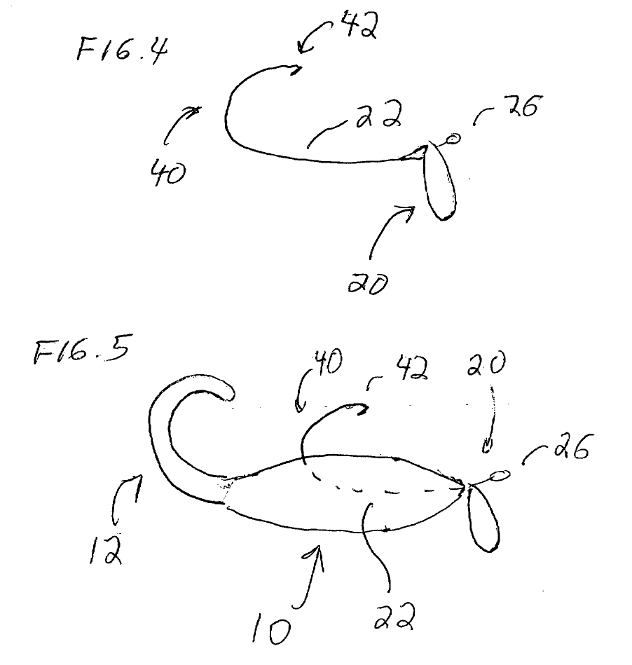

FIG. 4 is a side view of the diving bill 20. The hook 22 may be any size or shape and is conventionally constructed of a metal or metallic alloy. The hook includes a curved end 40 having a barbed tip 42. As depicted in FIG. 4, the diving bill does not include the weed guard 28.

FIG. 5 is a side view of the diving bill 20 attached to the artificial lure 10 in the preferred embodiment of the present invention. The diving bill is attached to the artificial lure by piercing the outer surface of the artificial lure 10 with the bared tip 42. The hook is slid through an interior portion of the lure and extending outwardly from the lure. Thus, in the preferred embodiment of the present invention, the hook is embedded within the lure and extended out to allow at least a portion of the curved end 40 and the barbed tip 42 to extend from the surface of the lure. The diving bill 20 is allowed to hang on or near the surface of the artificial lure. The diving bil is adjacent the eye 26.

With reference to FIGS. 2-5, the operation of the diving bill 20 will now be explained. Without the diving bill 20, the artificial lure 10 does not provide any ancillary movement as seen in a crank bait. The diving bill 20 is attached to the artificial lure by piercing the barbed tip 42 through the exterior surface of the artificial lure. The hook is pressed through the interior of the lure and extended out to allow a portion of the curved end 40 and the barbed tip 42 to be exposed beyond the lure. The lure is attached to a fishing line and cast into the water. The diving bill allows the lure to move or wobble in a manner similar to a crank bait.

The present invention provides several distinct advantages. The diving bill is attachable to any artificial lure. The diving bill enables any lure to move through the water in a more life-like manner. In addition, a fisherman may now provide a modification to all his artificial lure without forcing the fisherman to buy completely new artificial lure. The diving bill is removable as desired by the fisherman.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. An attachable diving bill and hook for use with an artificial lure, the attachable diving bill comprising:
a diving bill;
a hook having a curved end and a tip, the hook attached to the diving bill; and
whereby the diving bill is attached to the artificial lure by attaching the hook through the artificial lure with the tip being exposed.

2. The attachable diving bill and hook of claim 1 wherein the diving bill includes a support mold, the hook being integrated within the support mold.

3. The attachable diving bill and hook of claim 1 wherein the tip pierces the artificial lure and a portion of the curved end and tip is exposed from the artificial lure.

4. The attachable diving bill and hook of claim 1 wherein the diving bill is flat.

5. The attachable diving bill and hook of claim 1 further comprising a weed guard attached to the diving bill, the weed guard extending from the diving bill.

6. The attachable diving bill and hook of claim 1 wherein the diving bill enables the artificial lure to travel through the water with a motion simulating a marine life form.

7. The attachable diving bill and hook of claim 1 further comprising an eye for attaching a fishing line to the attached fishing bill.

8. The attachable diving bill and hook of claim 1 wherein the diving bill is constructed of metal.

9. The attachable diving bill and hook of claim 1 wherein the diving bill is constructed of a weighted soft or hard plastic.

10. An artificial lure having an attachable diving bill and hook, the artificial lure comprising:
an artificial lure having an exterior surface and an interior portion; and
a diving bill, the diving bill having a hook with a curved end and a tip, the hook attached to the diving bill;
whereby the diving bill is attached to the artificial lure by attaching the hook through the artificial lure with the tip being exposed.

11. The artificial lure of claim 10 wherein the diving bill enables the artificial lure to move through the water in a manner similar to a crank bait.

12. The artificial lure of claim 10 wherein the tip pierces the artificial lure and the curved end and tip is extended from the exterior surface and exposed from the artificial lure

13. The artificial lure of claim 10 wherein the diving bill includes a support mold, the hook being integrated within the support mold.

14. The artificial lure of claim 10 wherein the diving bill is flat.

15. The artificial lure of claim 10 further comprising a weed guard attached to the diving bill, the weed guard extending from the diving bill.

16. The artificial lure of claim 10 wherein the diving bill enables the artificial lure to travel through the water with a motion simulating a marine life form.

17. The artificial lure of claim 10 further comprising an eye for attaching a fishing line to the attached fishing bill.

18. The artificial lure of claim 10 wherein the diving bill is constructed of metal.

19. The artificial lure of claim 10 wherein the diving bill is constructed of a weighted soft or hard plastic.

20. An attachable diving bill and hook for use with an artificial lure, the attachable diving bill comprising:
a diving bill having a support mold, the diving bill being planar;
a hook having a curved end and a tip, the hook integrated into the support mold; and
whereby the diving bill is attached to the artificial lure by piercing an exterior surface of the artificial lure with the hook and allowing the tip to be exposed.
